(19) United States
(12) Patent Application Publication
(10) Pub. No.: US 2024/0423142 A1
(43) Pub. Date: Dec. 26, 2024

(54) STUMP GRINDING TOOTH HAVING COLLISION INTERCEPTOR

(71) Applicant: Green Manufacturing, Inc., Morenci, MI (US)

(72) Inventor: Brian P. Holly, Onsted, MI (US)

(21) Appl. No.: 18/701,344

(22) PCT Filed: Dec. 6, 2022
(86) PCT No.: PCT/US2022/080978

§ 371 Date: Apr. 15, 2024

Related U.S. Application Data
(63) Continuation of application No. 29/818,386, filed on Dec. 8, 2021, now Pat. No. D006075.
(60) Provisional application No. 63/287,298, filed on Dec. 8, 2021.

(51) Int. Cl. A01G 23/06

(52) U.S. Cl. CPC A01G 23/067

(57) ABSTRACT

A tree stump grinding tooth has a carbide cutting tip at one end of an elongated shank. The cutting tip is circular with its cutting edge formed about the periphery. The cutting tip has a tooth face that includes a collision interceptor, in the form of an atoll. The atoll is an annular, ridge-like formation arising from the tooth face. Around the exterior of the atoll is a trough-like annular dish. A basin is inset from the atoll. The atoll has a crest that stands proud on the cutting tip. A radially inner flank of the atoll has a straight conical slope of approximately 45°. A radially outer flank of the atoll has an ogee shape.

### CROSS REFERENCE TO RELATED APPLICATIONS

This application claims priority to U.S. Provisional Patent Application No. 63/287,298 filed on Dec. 8, 2021 and also to US Design patent application Ser. No. 29/818,386 filed on Dec. 8, 2021, the entire disclosures of which are hereby incorporated by reference and relied upon.

### BACKGROUND OF THE INVENTION

Field of the Invention. The present invention relates generally to a stump cutting apparatus and, more specifically, to an indexable replaceable cutting tip for a stump grinding machine.

Description of Related Art. A typical stump grinder includes a plurality of cutting teeth mounted around the cutting periphery of a cutting wheel. Individual teeth on the wheel incrementally grind away the stump by reducing the solid wood to small chips or shavings. Tool holders, sometimes referred to as pockets or mounting blocks, secure the teeth to the cutting wheel. Each tooth has a cutting tip or bit made of a solid material such as tungsten carbide and a generally cylindrical shank that extends through a socket in the holder.

Since stump grinders operate in natural environments in which various objects can be lodged in the base of a tree among its roots, maintenance of the teeth is frequent. During the stump grinding process, rocks and other hard objects are inevitably encountered. Maintaining a sharp, serviceable edge on each tooth has traditionally been a tedious and time-consuming task for those engaged in operating and servicing stump grinding equipment. When a tooth strikes something hard such as an embedded stone, the cutting edge often breaks.

In the best of scenarios, the machine operator notices a telltale cue (visual, haptic or audible) indicating that a tooth has struck an embedded hard object. The operator stops the stump removal process to assess the situation and, if necessary, remove the mysterious hard object. However, a less-ideal scenario is often the case, in which without sufficient warning the machine strikes and immediately dislodges a mysterious hard object. The loose, dislodged hard object shifts into the path of the rotating chipper teeth. When a stone or other hard object collides with a cutter tooth squarely in the middle of its leading face, as illustrated in FIGS. 9 and 10, catastrophic damage to the cutting tooth may occur.

There is therefore a need in the art for an improved tree stump grinding tooth that is better able to resist damage when a stone or hard object collides squarely in the middle of its leading face.

### BRIEF SUMMARY OF THE INVENTION

According to a first aspect of the invention, a tree stump grinding tooth comprises a shank that extends along, and is generally centered about, a longitudinal tooth axis. The shank is generally cylindrical and has opposite ends. A head is attached to one end of the shank. Screw threads are formed in the other end of the shank. The head includes a cutting tip fabricated from a carbide material. The cutting tip has a circular periphery centered about the tooth axis and defining an outer cutting edge. The cutting tip has a tooth face set inside the outer cutting edge. The tooth face includes a collision interceptor in the form of an atoll inset from the cutting edge. The atoll comprises an uninterrupted annular ridge. The tooth face includes an annular dish located concentrically between the outer cutting edge and the atoll.

According to a second aspect of the invention, a tree stump grinding tooth assembly comprises a shank extending along, and generally centered about, a longitudinal tooth axis. The shank is generally cylindrical and has opposite ends. A head is attached to one end of the shank and screw threads are formed in the other end of the shank. A nut is operatively threaded onto the screw threads of the shank. A hermetic spring, fabricated from an elastomeric material, is operatively disposed on the shank adjacent the nut. The hermetic spring has a nose and a foot adapted to engage the nut. A bellows section is disposed between the nose and the foot. The head includes a carbide cutting tip. The cutting tip has a circular periphery centered about the tooth axis and defining an outer cutting edge. The cutting tip has a tooth face set inside the outer cutting edge. The tooth face of the cutting tip includes a collision interceptor in the form of an atoll inset from the cutting edge. The atoll comprises an uninterrupted annular ridge. An annular dish is located concentrically between the outer cutting edge and the atoll.

The tooth of this present invention is designed to significantly reduce the chances of cutting tip failure by strategically configuring the tooth face to include a collision interceptor in the form of an atoll inset from said cutting edge. The atoll is an annular, ridge-like formation arising from the tooth face. On the exterior of the atoll is a trough-like annular dish. When a tooth according to this invention strikes a stone or hard object squarely on its face, the impact forces are distributed through the atoll and across the entire body of the cutting tip, thus reducing the likelihood of catastrophic damage. Furthermore, any chipping that may occur to the atoll will not affect the cutting performance of the tooth, thereby helping to preserve the precious outer edge of the cutting tip.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is an environmental view showing a tree stump grinding wheel assembly according to an exemplary embodiment of the invention;

FIG. 2 is a perspective view of an indexable tooth according to an embodiment of the invention assembled for use with a pocket or holder;

FIG. 3 is an exploded view of the combination holder and indexable tooth of FIG. 2;

FIG. 4 is a front perspective view of a carbide cutting tip according to an embodiment of the invention;

FIG. 5 is a rear perspective view of the carbide cutting tip of FIG. 4;

FIG. 6 is a cross-sectional view taken generally along lines 6-6 of FIG. 4;

FIGS. 7A-C are simplified illustrations depicting a progression or sequence of movements in which the indexable teeth of this invention expose and dislodge an embedded hard object;

FIG. 8 is a close-up view showing the carbide cutting tip of FIGS. 7A-C making contact with an embedded hard object;

FIG. 9 is view as in FIG. 8, but showing the carbide cutting tip of a prior art design making contact with an embedded hard object; and

FIG. 10 shows the prior art cutting tip of FIG. 9 damaged by collision with the embedded hard object.

### DETAILED DESCRIPTION OF THE INVENTION

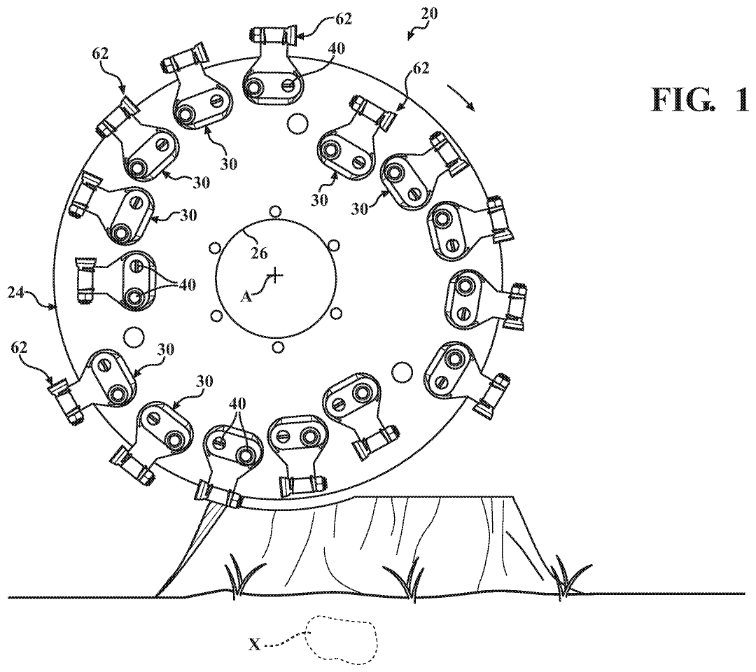

Referring to the figures, wherein like numerals indicate like or corresponding parts throughout the several views, a tree stump grinding wheel assembly is generally shown at 20 in FIG. 1. An illustrative tree stump 22 is depicted in partially removed condition. An exemplary rock X is shown embedded in the earth below the stump 22, possible entwined within its roots.

The assembly 20 includes a wheel, generally indicated at 24. The wheel 24 has a hub 26 defining a central axis of rotation A. In the illustration, the hub 26 is a large hole centered on the central axis A and surrounded by six lug bolt holes. Naturally, the configuration of the hub 26 is designed to suit the machine to which it will be attached.

In the exemplary embodiment of FIG. 1, the wheel 24 is shown in the traditional form having a circular cutting periphery. Wheels 24 of this type are usually made of one-piece from heavy-gauge plate steel for durability and inertial mass. However, the wheel 24 can take other forms, including but not limited to two-bladed and four-bladed spoke types, as well as other suitable configurations. The four-bladed spoke type, for example, can be made in multiple pieces, such as the Quadwheel® wheel marketed worldwide by Green Manufacturing Inc., the Applicant of this present invention.

Regardless of cutting periphery shape, the wheel 24 will have left and right sides as is well-known in the art. Only one side of the wheel 24 is visible from the perspective of FIG. 1. The central axis A passes perpendicularly through the left and right sides of the wheel 24 at the hub 26. A plurality of pocket holes 28 are disposed around the cutting periphery. The pocket holes 28 are through-holes opening into the left and right sides of the wheel 24. The pocket holes 28 are arranged in circumferentially-spaced pairs. For each pair, the center of the pocket hole 28 will be radially equidistant from the central axis A. However, the radial distance of one pair of pocket holes 28 may or may not be closer to or further from the central axis A than its adjacent neighboring paid of pocket holes 28. This latter detail can be discerned from FIG. 1, even though the pocket holes 28 are obscured from view.

The tree stump grinding wheel assembly 20 includes a plurality of holders, each generally indicated at 30. The plurality of holders 30 are distributed about the wheel 24 in any one of many strategic patterns as may be dictated by the application. In many applications, it is desirable to distribute one half of the plurality of holders 30 on the left side of the wheel 24 and the other half of the plurality of holders 30 on the right side of the wheel 24. However, this may not always be the case.

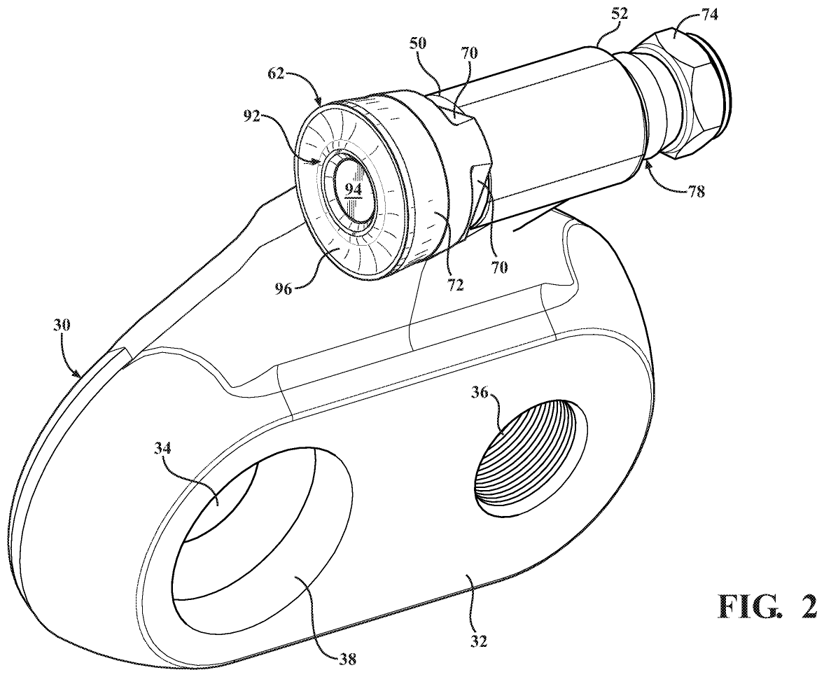

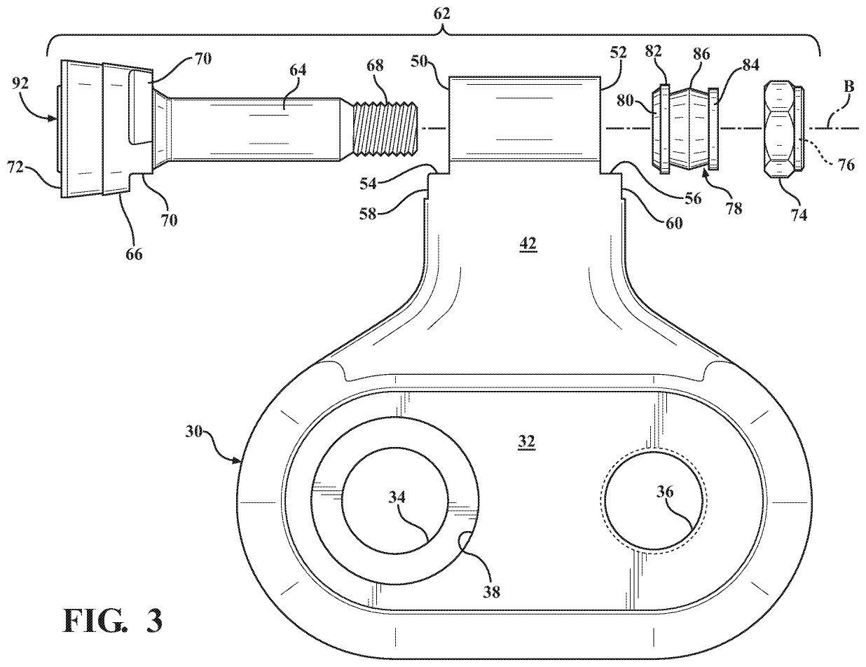

Each holder 30 has a base 32, which provides a solid foundation for attachment to the wheel 24. The base 32 has an inside surface and an outside surface. The inside surface of the base 32 is adapted to directly engage either the left side or the right side of the base 32. Each base 32 may be conjured with a pass-through hole 34 and a threaded hole 36 to enable installation on either the right or left side of the wheel 24. The pass-through hole 34 may be configured with a counterbore 38 in the outside surface of the base 32, via which the head of a mounting bolt 40 can be recessed. In FIGS. 2 and 3, the pass-through hole 34 is stationed on the left and the threaded hole 36 is stationed to the right when viewed toward the outside surface. However, this arrangement can be switched so that the pass-through hole 34 is on the right and the threaded hole 36 is on the left. In still further contemplated embodiments, the base can be fitted with exclusively pass-through holes 34 or alternatively exclusively threaded holes 36.

For each holder 30, the pass-through hole 34 and threaded hole 36 are adapted to align with one pair of pocket holes 28 in the wheel 24. In many installations, two holders 30 will be disposed, respectively, on the left and right sides of the wheel 24 and aligned with a common pair of pocket holes 28. Mounting bolts 40 are installed through the pass-through hole 34 of a holder 30 on one side of the wheel 24, through the aligned pocket hole 28, and screwed turned into the threaded hole 36 on the opposing holder 30. With both mounting bolts 40 tightened, the two opposing holders 30 sandwich the wheel 24, creating a secure and easily serviceable connection. Although not shown, a lock washer or other anti-rotation feature can be included to reduce the risk that the mounting bolts 40 will unexpected work themselves loose in operation.

Each holder 30 includes a neck 42 extending from the base 32. The neck 42 can take various shapes, depending largely on the application and other factors. In some cases, the neck 42 will extend nearly radially from the base 32. In other cases, the neck 42 will be canted or offset from the base 32, as shown in FIG. 2. Many neck 42 configurations are possible. The neck 42 has a distal end spaced from the base 32, in which a socket is formed. The socket extends more or less cylindrically along a tooth axis B, which is generally perpendicular to the central axis of rotation A, but does not intersect the central axis A. The socket has a forward opening and a rearward opening. Each opening may (optionally) be formed with a countersink. That is, either or both of the forward and rearward openings may be conically widened such as is usually achieved with a reaming tool or other appropriately shaped cutter.

The distal end of the neck 42 has a forward face 50 and a rearward face 52. The forward face 50 and the rearward face 52 are each disposed perpendicular to the tooth axis B. The distal end of the neck 42 also includes a forward shoulder 54 and a rearward shoulder 56. The forward shoulder 54 perpendicularly adjoins the forward face 50 adjacent the forward opening of the socket. And likewise, the rearward shoulder 56 perpendicularly adjoins the rearward face 52 adjacent the rearward opening of the socket. The distal end of the neck 42 has a forward clearance notch and a rearward clearance notch. Thus, in the illustrated examples, the shoulders 54, 56 form ledge-like extensions projecting at right angles from the respective forward 50 and rearward 52 faces. Optionally, the neck 42 can include forward 58 and rearward 60 clearance notches. Each clearance notch 58, 60 is shown intersecting its respective shoulder 54, 56, however the size and location of a clearance notch, if any, can vary substantially based on the design particulars of the assembly 20.

An indexable tooth 62 is disposed in each holder 30. Each indexable tooth 62 has a shank 64 that is slidably received in the socket in the distal end of the neck 42. In the example of FIG. 3, the shank 64 is shown to be generally cylindrical to achieve a slip-fit inside the socket, however a circular cross-section is more convenience than necessity. The shank 64 extends between first and second ends. At the first end is located a head 66. A frustoconical interface may be provided at the first end of the shank 64, directly adjacent the head 66. In the illustrated examples, screw threads 68 are formed in the second end. In this embodiment, the indexable tooth 62 takes a bolt-like appearance.

The head 66 includes at least one flat 70. However, more commonly a plurality of flats 70 are provided. The flats 70 can take different forms. In the illustrated examples, the plurality consists of three flats 70 arranged in an equilateral triangular pattern, a characteristic of indexable teeth sold globally under the brand Greenteeth® by Green Manufacturing, Inc. (Morenci, Michigan USA). However, in other contemplated embodiments, the plurality could be four flats 70 arranged in a square pattern (as under the head of a carriage bolt), or the plurality could be six flats 70 arranged in a hex pattern, and so on with any number of flats. And in a still further contemplated example of equivalents, the head 66 includes only one flat 70, but the configuration of the shoulders 54, 56 is altered to enable indexing of the tooth 62. Moreover, many different indexing strategies may be devised with the same ultimate aim, which is to enable the indexable tooth 62 to be rotated in predetermined increments about the tooth axis B in order to refresh its cutting ability during routine serving.

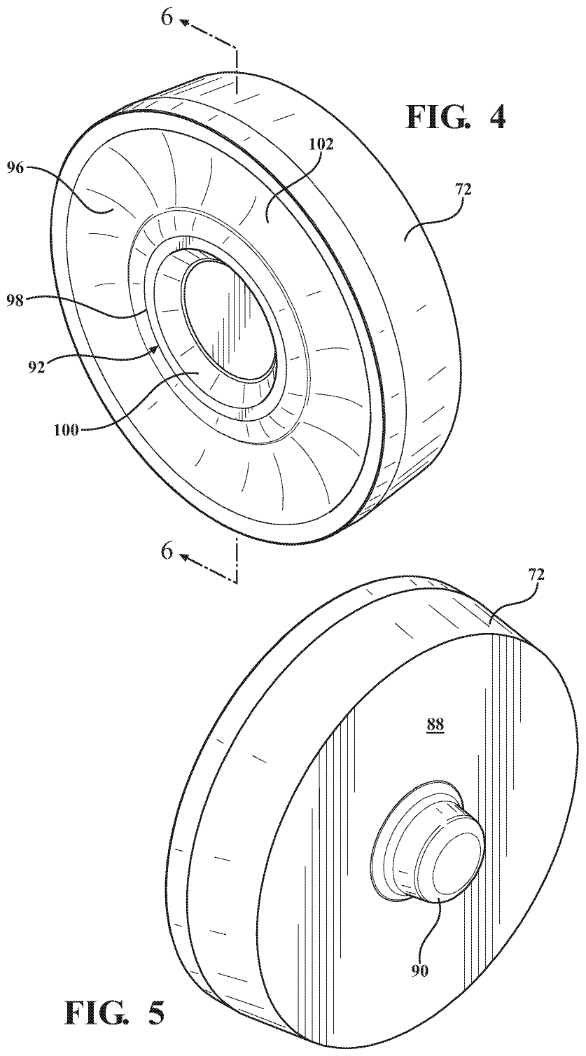

Furthermore, the head 66 may be fitted with a hardened cutting tip 72. The cutting tip 72 may, for example, be fabricated from a carbide material or high-speed steel or other suitable composition. In the illustrated examples, the cutting tip 72 has a circular periphery. The face of cutting tip 72 is of particular significance, and will be described subsequently in greater detail in connection with FIGS. 4-8.

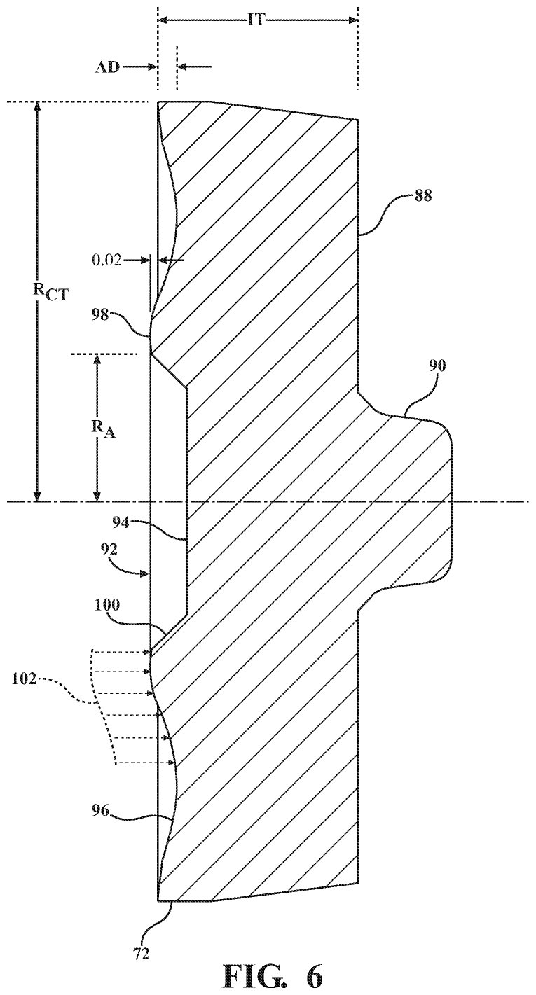

Referring still to FIGS. 2 and 3, it can be seen that the indexable tooth 62 is installed into the holder 30 by inserting the second end of the shank 64 through the forward opening in the socket. Ideally, but not necessarily, the holder 30 is designed to operate reversibly, in either direction, such that the forward and rearward designations are interchangeable. That is to say, except for the pass-through 34 and threaded 36 holes, the holder 30 is mirrored about a vertical plane. In this manner, identical holders 30 can be placed back-to-back as in FIG. 5 and it will be understood that the forward features of one holder 30 are the rearward features of its neighbor, and vise-versa. The insertion of the indexable tooth 62 determines which features of the holder 30 are forward features, and which are rearward.

The indexable tooth 62 is fully inserted into the socket so that the backside of the head 66 comes into contact with the forward face 50. The previously mentioned conical transition acts like a pilot by seating within the countersink of the forward opening thus centering the head 66 along the tooth axis B. It can be seen from FIG. 2 that the head 66 protrudes from the forward face 50 of the socket, presenting the cutting tip 72 for stump grinding action. The indexable tooth 62 is prevented from rotating within the socket by one of its flats 70 engaged by the forward clearance notch. That is, when the head 66 is pressed against the forward face 50, one of its flats 70 is seated alongside the forward shoulder 54, which inhibits rotation of the shank 64. The aforementioned forward clearance notch 58 accommodates the head 66 so that full and square engagement occurs at the forward face 50 rather than further down on the neck 42.

The length of the shank 64 is determined so that a portion of its second end protrudes from the rearward face 52 of the socket when the backside of the head 66 engages the forward face 50. A retainer 74 is operatively secured to the second end of the shank 64. The retainer 74 can take different forms. In examples of FIGS. 1-3, the retainer 74 is a nut threaded onto the screw threads 68 to secure the indexable tooth 62 in an operative condition in the holder 30, however this is but one option. The nut 74 can be of any suitable type. In the illustrated examples, the nut 74 is of a self-locking type having a nylon insert 76 to resist unscrewing. In another contemplated embodiment, the retainer 74 could be C-clip and instead of threads 68 one or more ring-grooves are formed on the second end of the shank 64. In another contemplated embodiment, the retainer 74 could be push nut adapted to grip by barbed friction a smooth exterior of the second end of the shank 64. In a still further embodiment, the retainer 74 could be a cotter pin adapted to fit in one or more holes piercing the second end of the shank 64. Those of skill in the art will envision other methods to establish a secure retainer 74 onto the second end of the shank 64. Preferably, the retainer 74 includes a generally flat bearing surface on its forward-facing side or end. The flat bearing surface is presented perpendicular to the tooth axis B.

The assembly 20 is shown including an optional hermetic spring, generally indicated at 78. The hermetic spring 78 is operatively disposed on the shank 64 between the retainer 74 and the rearward face 52 of the of the socket for performing a biasing function while concurrently creating an airtight seal at the rearward side of the neck 42. The hermetic spring 78 is capable of blocking/excluding all fluids and granular debris. Any and all kinds of debris are repelled by the hermetic spring 78 and denied entrance into the socket through the rearward opening. Moreover, the hermetic spring 78 actively sheds debris from accumulating in the region between retainer 74 and neck 42. In this way, there is little-to-no build-up of contaminates around the retainer 74.

In contrast, a traditional coil spring would enable fluid and granular contaminates to enter the socket, thus binding/seizing the shank 64 immovably in the holder 30 so that it resists indexing to expose a fresh cutting edge and/or replacement. Furthermore, dirt and solid particles will become impacted in-between the coils of a traditional compression spring, thus defeating its resiliency and effectively locking the tooth 62 in the socket. The hermetic spring 78 of the present invention suffers from none of the problems attributed to traditional coil springs.

The hermetic spring 78 is fabricated from an elastomeric material. An appropriately selected resilient, elastomeric material will have rubber-like properties, in that it will be able to compress under loading but regain its original shape when the load is removed. Suitable elastomeric materials can include both natural and synthetic rubbers, urethane, polybutadiene, silicone, and neoprene, just to name a few of the many possibilities. A suitable elastomeric material will have a wide working temperature that corresponds generally with year-round environmental conditions, perhaps in the range of about 0°-115° F., or at least ˜20°-100° F. This range could be narrowed for applications restricted to specific climates or seasons. For example, certain hermetic springs 78 perhaps colored blue could be intended for extreme cold weather (i.e., Winter) use; certain hermetic springs 78 perhaps colored green could be intended for mid-range weather (i.e., Spring-Fall) use; and certain hermetic springs 78 perhaps colored red could be intended for extreme hot weather (i.e., Summer) use. Naturally, many possibilities exit. Other important factors in the selection of a suitable elastomeric material can include hardness vs. softness, ageing resistance, abrasion resistance, chemical resistance, etc.

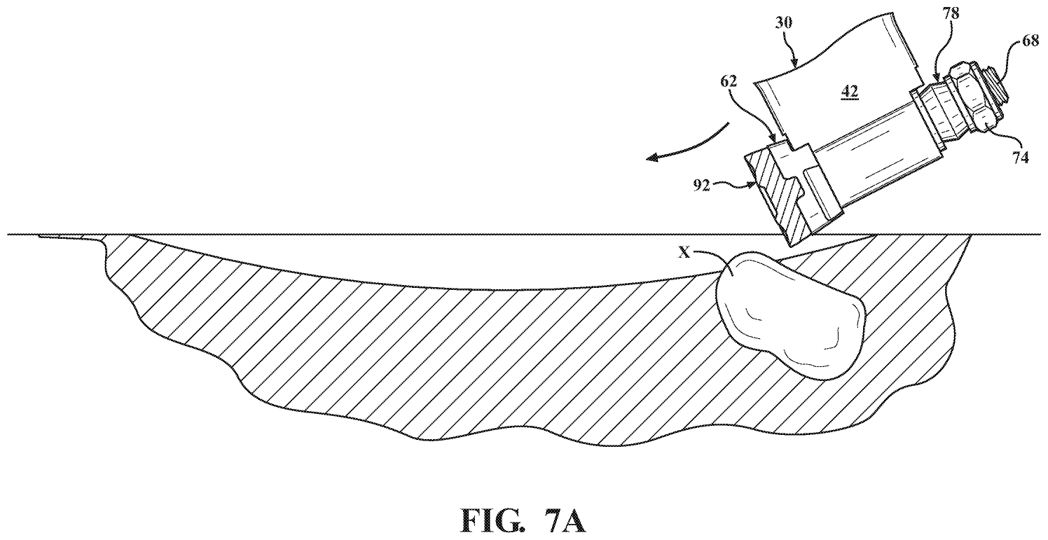

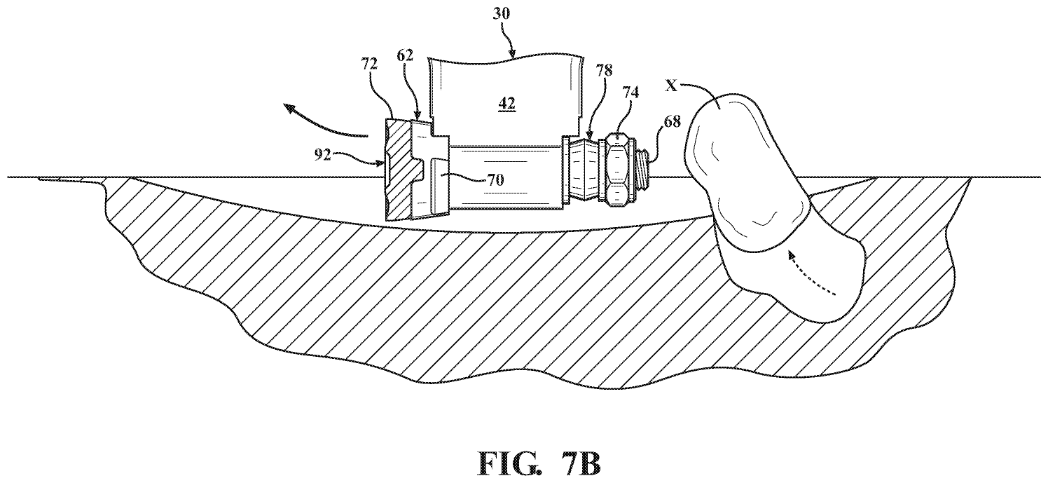

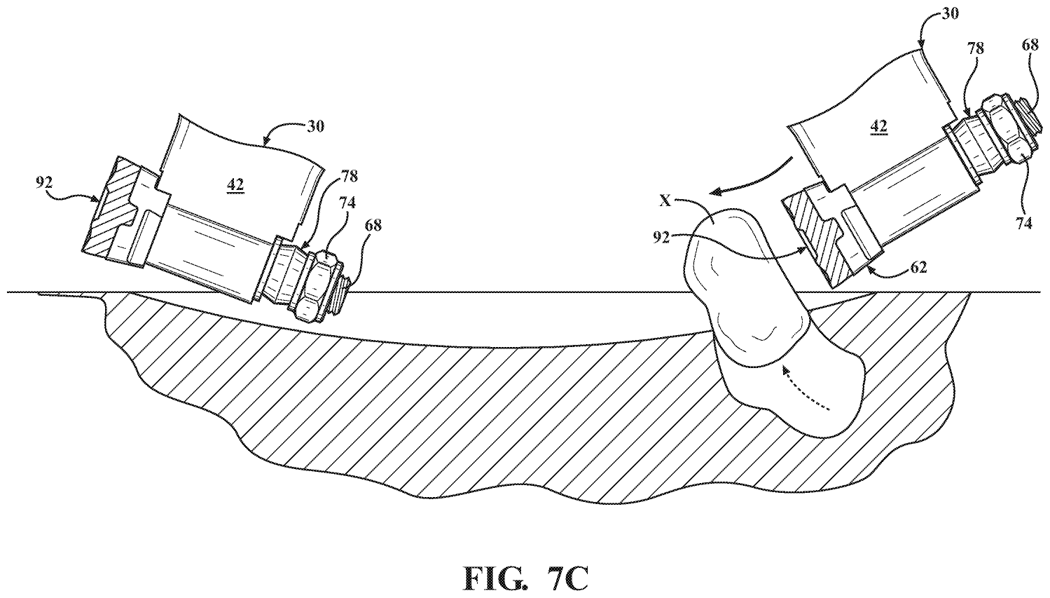

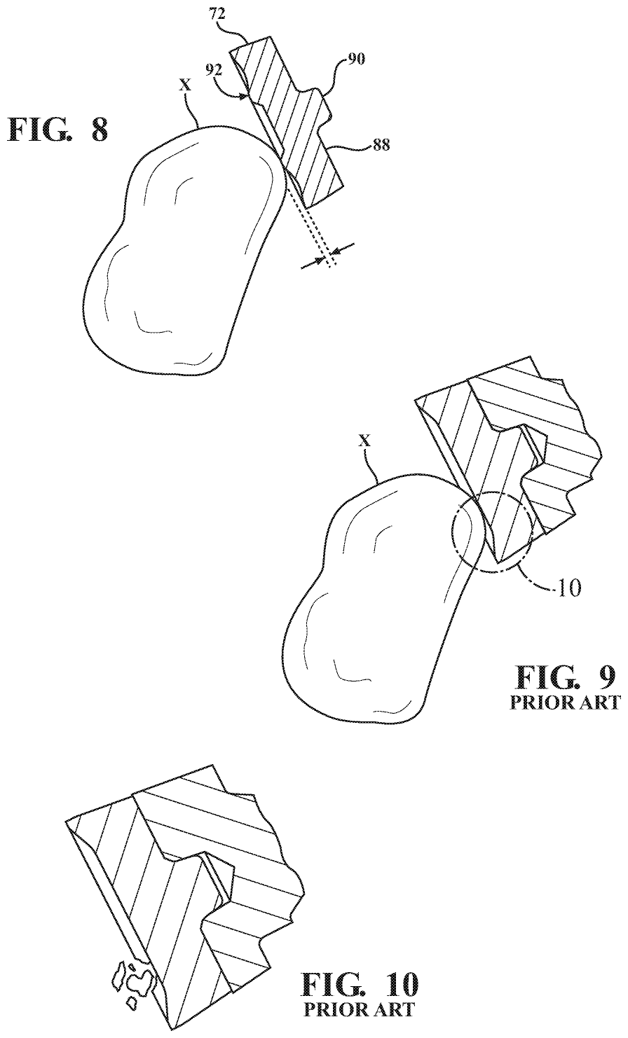

The hermetic spring 78 is described in greater detail in similar to that described in US Patent Publication No. 2022/0287252 to Holly, published Sep. 15, 2022, the entire disclosure of which is hereby incorporated by in permitting jurisdictions. In particular, the hermetic spring 78 is shown having a nose 80. The nose 80 is shaped with a tapered point so that it will self-seat in the countersink at the rearward opening of the socket. A flange 82 surrounds the tapered point feature of the nose 80. As best seen in FIGS. 7 and 8, the flange 84 directly abuts the rearward face 52 of the neck 42, both establishing a limit of penetration and also perfecting a seal aided by the compression of the hermetic spring 78. Thus, a fluid tight seal is created by the interface of tapered nose 80 pressed into the countersink rearward opening, combined with the interface of flange 82 pressed against the rearward face 52. At least the flange 82 is full circular (i.e., without gaps), but preferably both nose 80 and flange 82 are without gaps through which debris could infiltrate the hermetic spring 78.

The hermetic spring 78 is shown including a ring-like foot 84 opposite the nose 80. The foot 84 is full circular (i.e., unbroken) and adapted to engage the flat forward-facing bearing surface of the nut 74. A fluid tight seal is perfected by the squared interface of foot 84 pressed against the bearing surface of the nut 74, aided by the compressive force of the loaded hermetic spring 78.

A bellows section 86 is disposed between the nose 80 and the foot 84. The bellows section 86 can take many different forms. In the illustrated examples, the bellows section 86 has the shape of an accordion-like body of revolution, with one central annular bulge or ridge. That is, a single convex coil or ridge establishes a natural central outward flex point when compressed.

After a period of use in service, the cutting tips 72 of each tooth 62 will become dull. In order to improve cutting efficiency, each tooth 62 can be rotationally indexed to expose a fresh portion of its cutting edge by displacing the head 66 so as to cause the hermetic spring 78 to yield. Then while the hermetic spring 78 is compressed, the indexable tooth 62 is rotated, right or left, to bring a different flat 70 into registry with the forward shoulder 54. The biasing action of the hermetic spring 78 returns the indexable tooth 62 to the operational position of FIG. 2. This indexing operation can be accomplished in a few seconds and typically without the aid of tools. The example of FIG. 1 portrays a wheel assembly 20 having thirty teeth 62 (fifteen on each of the left and right sides). If it is estimated that the average person of skill in this art can index each tooth in ˜5-10 seconds, the indexing operation for the entire wheel assembly can be completed in 5 minutes or less. This rapid maintenance program enabled by the present invention compares favorably to the prior art requirement in which the backing nut had to be loosened and re-tightened with a wrench.

Turning again to FIGS. 4-8, the cutting tip 72 is shown in detail having a circular periphery centered about the tooth axis B. The circular periphery defines the outer cutting edge, with the tooth face comprising all of the exposed area set inside the outer cutting edge. The tooth face is visible in the perspective of FIG. 4. Opposite the tooth face is a base 88, visible in the perspective of FIG. 5. FIGS. 4 and 5 show the cutting tip 72 from front and back perspectives. The base 88 may include a nub 90 centered on the tooth axis B. The nub 88 is configured to rest in a shallow hole in the shank head 66, so as to positively locate the cutting tip 72 during the manufacturing process, increase bonding surface area, and improve shear strength.

As previously mentioned, problems have traditionally been experienced when embedded hard objects X, like rocks for example, are embedded in or immediately below a stump 22 to be removed by grinding. (See FIG. 1.) When eventually uncovered, the hard object X has a tendency to collide with the face of a cutting tip 72, leading to catastrophic damage. The tooth 62 of this present invention is designed to significantly reduce the chances of cutting tip 72 failure by strategically configuring the tooth face to include a collision interceptor inset from said cutting edge. Throughout FIGS. 4-8, the collision interceptor is shown in the exemplary form of an atoll 92. The atoll 92 is an annular ridge-like formation arising from the tooth face. A basin 94 is inset from said atoll 92. The basin 94 may be generally flat, oriented perpendicular to the tooth axis B as perhaps best appreciated from the cross-sectional elevation of FIG. 6. On the exterior of the atoll 92 is a trough-like annular dish 96. The dish 96 is located concentrically between the outer cutting edge and the atoll 92.

In the detail of FIG. 6, it can be seen that the atoll 92 may have a ridge-like crest 98 centered about the tooth axis B, inset concentrically with respect to the circular outer cutting edge. The diameter of the crest 98 of the atoll 92 must not be too large or too small with respect to the circular outer cutting edge. In this illustration, the outer cutting edge is located by a radial measure R_{CT}, and the crest 98 of the atoll 92 is located by radial measure R_{A}. Preferably, the radial measure of the atoll (R_{A}) is at least about 30% of the radial measure R_{CT} of the outer cutting edge. And also preferably, the radial measure of the atoll (R_{A}) is no more than about 70% of the radial measure R_{CT} of the outer cutting edge. Expressed mathematically, this relationship could be stated:

$$0.3 {R}_{CT} \leq {R}_{A} \leq 0.7 {R}_{CT}$$

However, in more preferred embodiments, the relationship could be narrowed to:

$$0.4 {R}_{CT} \leq {R}_{A} \leq 0.6 {R}_{CT}$$

An in the illustrated examples, the relationship is closer to:

$$0.45 {R}_{CT} \leq {R}_{A} \leq 0.55 {R}_{CT}$$

When the radial measure of the atoll (R_{A}) is maintained within this dimensional range with respect to the radial measure R_{CT} of the outer cutting edge, the cutting tip 72 produces advantageously small chips of wood. When this dimensional relationship is not observed, the cutting tip 72 is more likely to produce less-desirable long curls of wood shavings. Long curls of wood occupy a larger volumetric space than small chips of wood. As a consequence, disposing of long curls of wood can be more difficult. In practice, many arborists attempt to dispose of the wood chips produced during the stump grinding process by filling in the crater and area surrounding where the tree stump formerly resided. When the residual wood ships are small in size, they will more densely pack into a limited space. In contrast, the undesirable long curls of wood would occupy a larger volume and thus be more difficult to dispose of on the jobsite.

Considering still the cross-section of FIG. 6, the atoll 92 can be seen having a radially inner flank 100 running from the crest 98 toward the tooth axis B, and a radially outer flank 102 extending from the crest 98 toward the outer cutting edge. That is to say, the radially inner flank 100 is that portion of the atoll 92 extending from the crest 98 to the basin 94. And the radially outer flank 102 is that portion of the atoll 92 extending from the crest 98 to the dish 96.

In the illustrated examples, the inner flank 100 is shown having a straight, conical slope of approximately 45 degrees (relative to the tooth axis B). The outer flank 102, on the other hand, has an ogee shape. The ogee shape of the outer flank 102 is believed to provide a particularly robust and durable design that enhances protection against strikes from hard objects X. Moreover, the ogee shape of the outer flank 102, which is highlighted in FIG. 6, facilitates a smooth curling of wood chips in operation.

Another distinctive feature of the atoll 92 is that its crest 98 stands proud of the outer edge of the cutting tip 72. This is visible throughout the illustrations, but expressly indicated in FIG. 6 where an exemplary stand-off distance of 0.02 inches is suggested. The exemplary stand-off distance of 0.02 inches remains a guide but is not limiting.

The collision interceptor is illustrated in the exemplary form of a continuous annular formation. In other contemplated embodiments, however, the collision interceptor could take a different form or configuration. For example, instead of an uninterrupted annular atoll 92, the collision interceptor could be segmented annularly. That is, the collision interceptor could present as a plurality of radial segments, crenulations, or other such discontinuous forms. In any configuration, however, the collision interceptor preferably stands proud of the outer edge of the cutting tip 72.

The operation and functionality of the present invention will be described in connection with FIGS. 7A-8. In use, the spinning wheel 20 may encounter a buried hard object X shown here in the exemplary form of a rock about the size of a common chicken egg. FIGS. 7A-7C suggest a sequence in which, according to FIG. 7A, a leading tooth 62 encounters the buried hard object X. The leading tooth 62 nicks the stone X in passing. Then as depicted in FIG. 7B, this disturbance causes the stone X to be dislodged out of its socket. Immediately thereafter, the next tooth 62 arrives as illustrated in FIG. 7C. Because the stone X has changed its position so dramatically, the next tooth 62 could strike the stone X squarely on its face.

FIG. 8 is an enlarged view showing a tooth 62 according to this invention as it strikes a stone X squarely on its face. Contact occurs on or near the crest 98 of the atoll 92. Because the atoll 92 is thickly formed with generous inner 100 and outer 102 flanks, the impact forces are distributed across the entire body of the cutting tip 72, thus reducing the likelihood of catastrophic damage. Furthermore, any chipping that may occur to the crest 98 of the atoll 92 will not affect the cutting performance of the tooth 62. Because the atoll 92 has intercepted the blow from the stone X, the precious outer edge of the cutting tip 72 is preserved.

FIG. 9 offers a contrast to FIG. 8. In FIG. 9, a prior art style cutting tip of the same diameter is shown colliding with a stone X of the same size. It can be seen how such a stone or other hard object X would be likely to impact the dished center face area, which could lead to a serous crack/fissure and/or chipping to the precious outer edge of the cutting tip as suggested in FIG. 10.

Returning to FIG. 6, a particularly advantageous relationship can be discerned between the depth (AD) of the dish 96 and the body thickness (IT) of the cutting tip 72. As mentioned, the cutting tip 72 is the carbide insert portion of the indexable tooth 62. The depth (AD) of the dish 96 is preferably held within a tolerance of 10-25% of the body thickness (IT) of the cutting tip 72 so that the aforementioned production of small chips of wood can be achieved while maintaining sufficient structural integrity of the cutting tip 72. Practically speaking, the cutting tip 72 (being made of carbide) is relatively expense and brittle compared to the remaining portions of the indexable tooth 62. Therefore, it is desirable to manufacture the cutting tip 72 as thin as possible for economic reasons, but as thick as possible for structural reasons. Too thin and the cutting tip 72 is susceptible to cracking in use—particularly upon collision with a hard object (see for example FIGS. 7A-8). There is therefore a range within which the competing economic and structural concerns may be optimized, and that range can be linked to the relationship between the depth (AD) of the dish 96 on the outer flank 102 and the body thickness (IT) of the cutting tip 72. By maintaining the depth (AD) of the dish 96 at 10-25% of the body thickness (IT), these several factors can be best accommodated.

For example, in cases where the body thickness (IT) of the cutting tip 72 is 0.25 inches, the depth (AD) of the dish 96 will be 0.025-0.0625 inches. Experimental data indicates that outside this range (0.10*IT≥AD≥0.25*IT), the cutting tip 72 is more likely to fail, produce long curls of wood shaving and/or be excessively expensive.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A tree stump grinding tooth comprising:
a shank extending along and generally centered about a longitudinal tooth axis, said shank being generally cylindrical and having opposite ends, a head attached to one end of said shank and screw threads formed in the other end of said shank, said head including a cutting tip, said cutting tip fabricated from a carbide material, said cutting tip having a circular periphery centered about said tooth axis and defining an outer cutting edge, said cutting tip having a tooth face set inside said outer cutting edge,
said tooth face including a collision interceptor in the form of an atoll inset from said cutting edge, said atoll comprising an uninterrupted annular ridge, said tooth face including an annular dish located concentrically between said outer cutting edge and said atoll.

2. The tree stump grinding tooth of claim 1 wherein said atoll has a radially outer flank extending from said crest to said dish, said outer flank having an ogee shape.

3. The tree stump grinding tooth of claim 1 wherein said cutting tip has a body thickness (IT), said dish having a depth (AD) between about 10-25% of said body thickness (IT).

4. The tree stump grinding tooth of claim 1 wherein said atoll has a radially inner flank running from said crest toward said tooth axis, said inner flank having a straight conical slope of approximately 45 degrees relative to said tooth axis.

5. The tree stump grinding tooth of claim 1 further including a basin inset from said atoll, said basin being generally flat and oriented perpendicular to said tooth axis,

6. The tree stump grinding tooth of claim 1 wherein said atoll has a crest centered about said tooth axis, said crest standing proud of said outer edge of said cutting tip.

7. The tree stump grinding tooth of claim 1 wherein said atoll has a crest centered about said tooth axis, the position of said outer cutting edge being indicated by a radial measure (RCT), the position of said crest being indicated by radial measure (RA), said radial measure (RA) of said crest being between about 30%-70% of said radial measure (RCT) of said outer cutting edge.

8. The tree stump grinding tooth of claim 1 wherein said atoll has a crest centered about said tooth axis, the position of said outer cutting edge being indicated by a radial measure (RCT), the position of said crest being indicated by radial measure (RA), said radial measure (RA) of said crest being between about 40%-60% of said radial measure (RCT) of said outer cutting edge.

9. The tree stump grinding tooth of claim 1 wherein said atoll has a crest centered about said tooth axis and inset concentrically with respect to said outer cutting edge, the position of said outer cutting edge being indicated by a radial measure (RCT), the position of said crest being indicated by radial measure (RA), said radial measure (RA) of said crest being between about 45%-55% of said radial measure (RCT) of said outer cutting edge.

10. A tree stump grinding tooth assembly comprising:
a shank extending along and generally centered about a longitudinal tooth axis, said shank being generally cylindrical and having opposite ends, a head attached to one end of said shank and screw threads formed in the other end of said shank, said head including a carbide cutting tip, said cutting tip having a circular periphery centered about said tooth axis and defining an outer cutting edge, said cutting tip having a tooth face set inside said outer cutting edge,
a nut operatively threaded onto said screw threads of said shank,
a hermetic spring operatively disposed on said shank adjacent said nut, said hermetic spring being fabricated from an elastomeric material, said hermetic spring having a nose, said hermetic spring having a foot adapted to engage said nut, a bellows section disposed between said nose and said foot,
said tooth face of said cutting tip including a collision interceptor in the form of an atoll inset from said cutting edge, said atoll comprising an uninterrupted annular ridge, said tooth face further including an annular dish located concentrically between said outer cutting edge and said atoll.

11. The assembly of claim 10 wherein said atoll has a radially outer flank extending from said crest to said dish, said outer flank having an ogee shape.

12. The assembly of claim 11 wherein said cutting tip has a body thickness (IT), said dish having a depth (AD) between about 10-25% of said body thickness (IT).

13. The assembly of claim 11 further including a basin inset from said atoll, said atoll having a radially inner flank running from said crest to said basin, said inner flank having a straight conical slope of approximately 45 degrees relative to said tooth axis.

14. The assembly of claim 13 wherein said basin is generally flat and oriented perpendicular to said tooth axis.

15. The assembly of claim 13 wherein said atoll has a crest centered about said tooth axis, said crest standing proud of said outer edge of said cutting tip.

16. The assembly of claim 15 wherein said atoll has a crest centered about said tooth axis, the position of said outer cutting edge being indicated by a radial measure (RCT), the position of said crest being indicated by radial measure (RA), said radial measure (RA) of said crest being between about 30%-70% of said radial measure (RCT) of said outer cutting edge.

17. The assembly of claim 15 wherein said atoll has a crest centered about said tooth axis, the position of said outer cutting edge being indicated by a radial measure (RCT), the position of said crest being indicated by radial measure (RA), said radial measure (RA) of said crest being between about 40%-60% of said radial measure (RCT) of said outer cutting edge.

18. The assembly of claim 15 wherein said atoll has a crest centered about said tooth axis, the position of said outer cutting edge being indicated by a radial measure (RCT), the position of said crest being indicated by radial measure (RA), said radial measure (RA) of said crest being between about 45%-55% of said radial measure (RCT) of said outer cutting edge.

19. A tree stump grinding tooth comprising:
a shank extending along and generally centered about a longitudinal tooth axis, said shank being generally cylindrical and having opposite ends, a head attached to one end of said shank and screw threads formed in the other end of said shank, said shank including a generally frustoconical interface directly adjacent said head, said head having three flats arranged in an equilateral triangular pattern, said head including a carbide cutting tip, said cutting tip having a circular periphery centered about said tooth axis and defining an outer cutting edge, said cutting tip having a tooth face set inside said outer cutting edge, said cutting tip having a base opposite said tooth face, said base including a locator nub centered on said tooth axis,
said tooth face including a collision interceptor, said collision interceptor comprising an atoll inset from said cutting edge, said atoll comprising an uninterrupted annular ridge, said tooth face including a basin inset from said atoll, said basin being generally flat and oriented perpendicular to said tooth axis, said tooth face including an annular dish located concentrically between said outer cutting edge and said atoll, said cutting tip having a body thickness (IT), said dish having a depth (AD) between about 10-25% of said body thickness (IT), said atoll having a crest centered about said tooth axis and inset concentrically with respect to said outer cutting edge, said crest standing proud of said outer edge, the position of said outer cutting edge being indicated by a radial measure (RCT), said atoll having a radially inner flank running from said crest to said basin, said atoll having a radially outer flank extending from said crest to said dish, said inner flank having a straight conical slope of approximately 45 degrees relative to said tooth axis, said outer flank having an ogee shape.

20. The tree stump grinding tooth of claim 19 wherein the position of said crest is indicated by radial measure (RA), said radial measure (RA) of said crest being between about 30%-70% of said radial measure (RCT) of said outer cutting edge.
